(19) United States
(12) Patent Application Publication
(10) Pub. No.: US 2022/0171028 A1
(43) Pub. Date: Jun. 2, 2022

(54) FLASH LIDAR

(71) Applicant: SUTENG INNOVATION TECHNOLOGY CO., LTD., Shenzhen (CN)

(72) Inventor: Songshan HOU, Shenzhen (CN)

(73) Assignee: SUTENG INNOVATION TECHNOLOGY CO., LTD., Shenzhen (CN)

(21) Appl. No.: 17/669,330

(22) Filed: Feb. 10, 2022

Related U.S. Application Data
(63) Continuation of application No. PCT/CN2019/100568, filed on Aug. 14, 2019.

(51) Int. Cl. G01S 7/481

(52) U.S. Cl. CPC G01S 7/4814; G01S 7/4813

(57) ABSTRACT

A flash LiDAR is provided and includes: an emitting assembly (3), a receiving assembly (4), a light blocking element (5), and a control assembly (6). The emitting assembly (3) includes at least one light-emitting element (31), configured to emit an outgoing laser to a detection region; the receiving assembly (4) is configured to receive a reflected laser returning after being reflected by an object in the detection region, where the emitting assembly (3) and the receiving assembly (4) are arranged abreast; and the light blocking element (5) is configured to block stray light directed to the receiving assembly (4).

### CROSS-REFERENCE TO RELATED APPLICATION

The present application is a continuation of International Application No. PCT/CN2019/100568, filed on Aug. 14, 2019, and also claims priority to Chinese Patent Application No. 201980002317.X, filed on Nov. 11, 2019, both of which are incorporated herein by reference in their entireties.

### TECHNICAL FIELD

The present application relates to the field of radar, and in particular, relates to flash LiDAR.

### BACKGROUND

A LiDAR is a system for emitting an outgoing laser to detect position, velocity, and other feature values of a target object, and is widely applied to the field of laser detection. The LiDAR is alternatively a system for emitting a laser of a specific wavelength in a specific direction to detect position, velocity, and other feature values of a target object.

During operation of the LiDAR, an outing laser emitted by a light source reaches the target object, and then is reflected by the target object. The reflected laser reflected by the target object is received by the receiving assembly. By analyzing the reflected laser, the LiDAR obtains a detection result. However, a receiving assembly of the existing LiDAR cannot receive sufficient light signals reflected by the target object in the near field, thereby causing inaccurate detection results in the near field.

### BRIEF SUMMARY

According to an aspect of the present disclosure, a flash LiDAR is provided.

The flash LiDAR may include:

an emitting assembly, including at least one light-emitting element, wherein the at least one light-emitting element is arranged in an array, and is configured to emit an outgoing laser to a detection region;

a receiving assembly, configured to receive a reflected laser returning after being reflected by an object in the detection region; and wherein the emitting assembly and the receiving assembly are arranged abreast;

a light blocking element, configured to block stray light directed to the receiving assembly; and

a control assembly, electrically connected with the emitting assembly and the receiving assembly.

Further, the emitting assembly and the receiving assembly may be arranged opposite each other in a horizontal direction and spaced apart, or the light-emitting element and the receiving assembly are arranged opposite each other in a vertical direction and spaced apart.

The emitting assembly may further include an emitting board, the light-emitting element is arranged on the emission board, the receiving assembly may include a receiving lens, a receiver, and a receiving board, the receiver is arranged on the receiving board, and the receiving lens is arranged on a front side of the receiver.

The flash LiDAR may further include a housing and a front cover, wherein the housing and the front cover are assembled to form a sealed accommodating groove, and the emitting assembly, the receiving assembly, and the light blocking element are all arranged in the accommodating groove.

Further, an incident end of the receiving lens may protrude from a plane in which a surface of the emitting board is located.

Further, the light blocking element may be a light blocking plate, and arranged between the emitting assembly and the receiving assembly, the emitting board is provided with a first light blocking groove, and the light blocking plate is inserted into the first light blocking groove and protrudes from the surface of the emission board.

Further, a cross-section of the light blocking plate may be line-shaped, L-shaped, or T-shaped.

Further, an inner surface of the housing is provided with a mounting groove, an end of the light blocking plate is inserted into the mounting groove, and the mounting groove is located on two opposite side walls of the housing.

Further, the light blocking element may be a first light blocking ring, and arranged at an incident end of the receiving lens, and the first light blocking ring is connected to a lens barrel at the incident end of the receiving lens.

Further, a cross-section of the first light blocking ring may be circular or arc-shaped, and the first light blocking ring is cylindrical or inverted conical.

The flash LiDAR may further include a mounting plate extending along the emitting board, toward a side of the receiving assembly, wherein the emitting board and the mounting plate are located on the same plane, the mounting plate is provided with a spacing hole corresponding to the receiving assembly, and the spacing hole and the emitting assembly are respectively located on two sides of the light blocking element.

Further, the light blocking element may be a second light blocking ring, and the second light blocking ring may be arranged around the spacing hole.

Further, the front cover may be a complete transparent sheet, or the front cover may be provided with an emitting window corresponding to the emitting assembly and a receiving window corresponding to the receiving assembly, and both the emitting window and the receiving window may be provided with the transparent sheet.

Further, a second light blocking groove may be provided on an inner side of the front cover, and the light blocking element is inserted into the second light blocking groove and protrudes from a surface of the front cover.

Further, wherein a flexible element may be provided between the front cover and the light blocking element, and two sides of the flexible element abut the front cover and the light blocking element respectively.

The control assembly may include a main control circuit board and a data processing circuit board which is electrically connected to the main control circuit board, the receiving board of the receiving assembly is electrically connected to the data processing circuit board, and the receiving board is configured to convert the reflected laser into an electrical signal and then transmit the electrical signal to the data processing circuit board.

Further, the data processing circuit board is fastened and connected to the main control circuit board, the data processing circuit board is provided with a first connector, and the receiving board is provided with a second connector that matches with the first connector.

Further, the emitting board and the inner surface of the housing are laminated, and an outer surface of the housing is provided with a plurality of heat sink ribs.

Further, the transparent sheet is coated with an anti-reflection layer.

The flash LiDAR includes the emitting assembly for emitting the outgoing laser to the detection region, and the receiving assembly for receiving the reflected laser. The emitting assembly and the receiving assembly are arranged abreast. Without a need of a mechanically movable component, the emitting assembly and the receiving assembly are used to detect the detection region, thereby implementing solid-state laser scanning and detection. Because the emitting assembly of the flash LiDAR uses the light-emitting element arranged in the array to emit outgoing lasers, the outgoing lasers are at a relatively large divergence angle, and as a result, some outgoing lasers are directly emitted to the receiving assembly. In addition, the outgoing lasers are reflected or scattered by a device (for example, the transparent sheet) inside the flash LiDAR before being emitted outward. Both these reflected or scattered lasers and the outgoing lasers directly emitted to the receiving assembly are collectively referred to as stray light. In existing art, the receiving assembly may receive the stray light before the reflected laser, and as a result, the receiving assembly may be saturated and cannot receive the reflected laser returning after being reflected by a short-range target object. The flash LiDAR provided in the present disclosure uses the light blocking element to stop the stray light from being directly emitted to the receiving assembly, so that the receiving assembly does not receive the stray light, thereby avoiding causing a problem of leading interference. In addition, the light blocking element stops the stray light from being directly emitted to the receiving assembly so that the receiving assembly can quickly respond to the reflected laser reflected by the short-range target object, and therefore, the receiving assembly can accurately and effectively detect the short-range target object. The control assembly identifies the target object by dealing with reflected laser received by the receiving assembly, thereby effectively reducing a short-range blind spot, ensuring accuracy and reliability of near-field detection of the flash LiDAR, and improving safety of the flash LiDAR as it is used.

### BRIEF DESCRIPTION OF THE DIAGRAMS

To explain the technical solution in embodiments in this disclosure, the following briefly introduces the accompanying drawings required for description in the embodiments. Obviously, the accompanying drawings in the following description are only some embodiments in this disclosure. A person of ordinary skill in the art may still derive other drawings from these accompanying drawings without creative efforts.

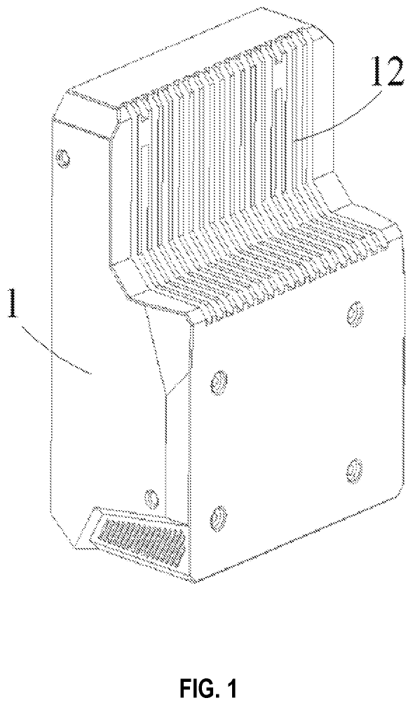

FIG. 1 is a schematic structural diagram of a flash LiDAR according to an embodiment in this disclosure;

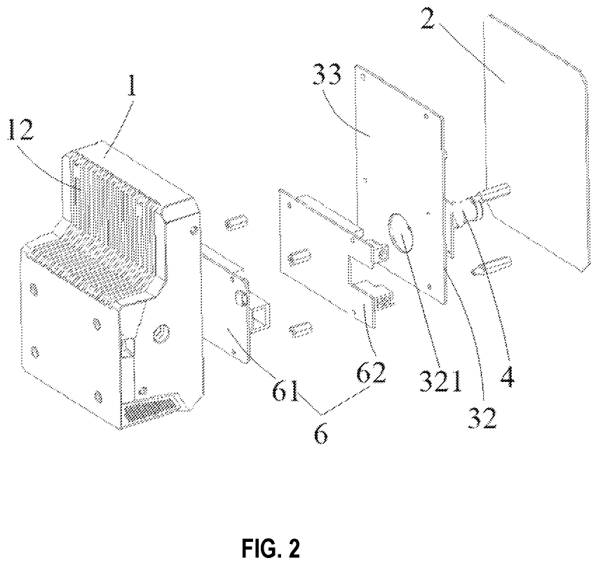

FIG. 2 is an exploded view of the flash LiDAR in FIG. 1 from a second perspective;

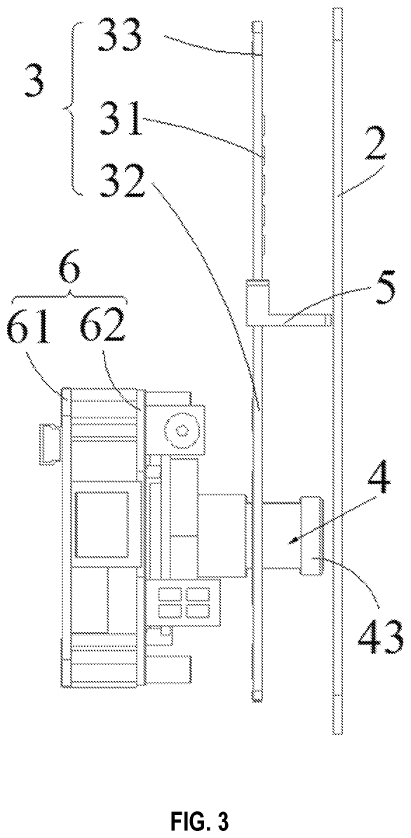

FIG. 3 is a schematic diagram of an inner structure of the flash LiDAR in FIG. 1 from a first perspective;

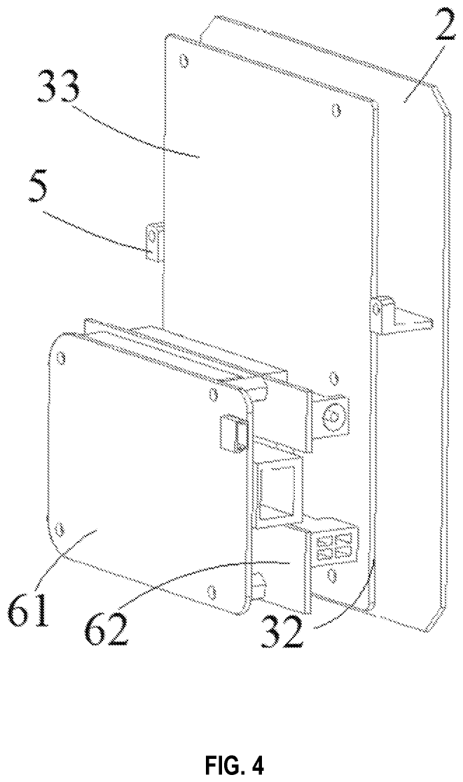

FIG. 4 is a schematic diagram of an inner structure of the flash LiDAR in FIG. 1 from a second perspective;

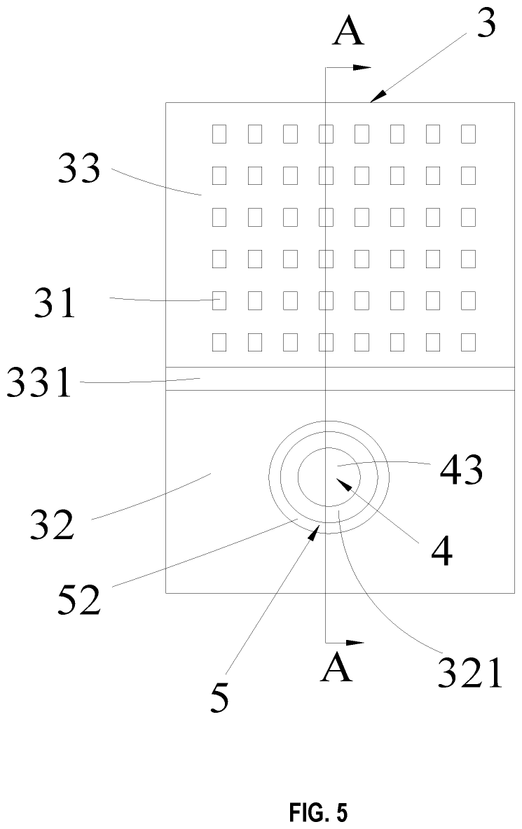

FIG. 5 is a schematic structural diagram of a mounting plate when the light blocking element is a second light blocking ring;

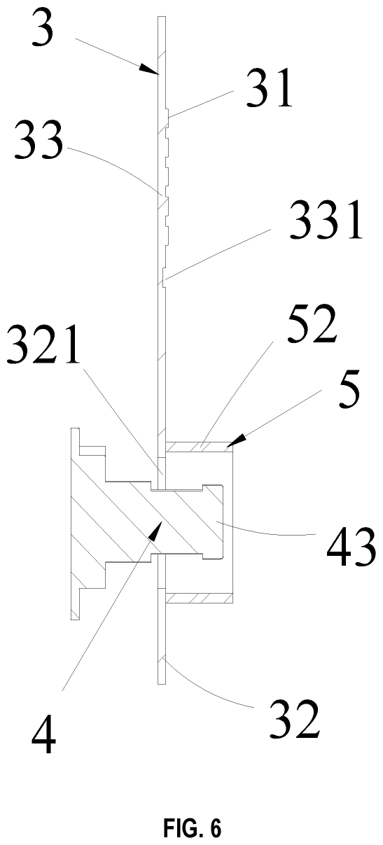

FIG. 6 is a cross-sectional view taken along the line A-A in FIG. 5;

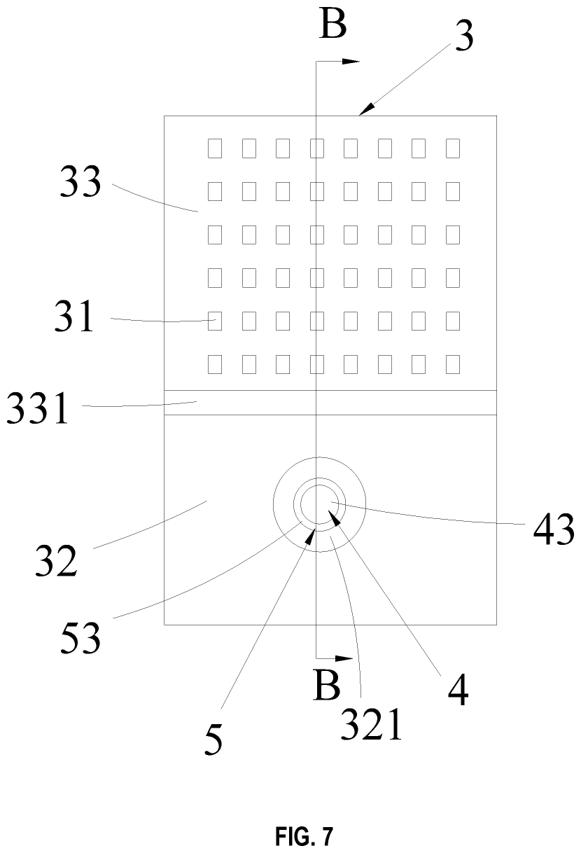

FIG. 7 is a schematic structural diagram of a mounting plate when a light blocking element is a first light blocking ring;

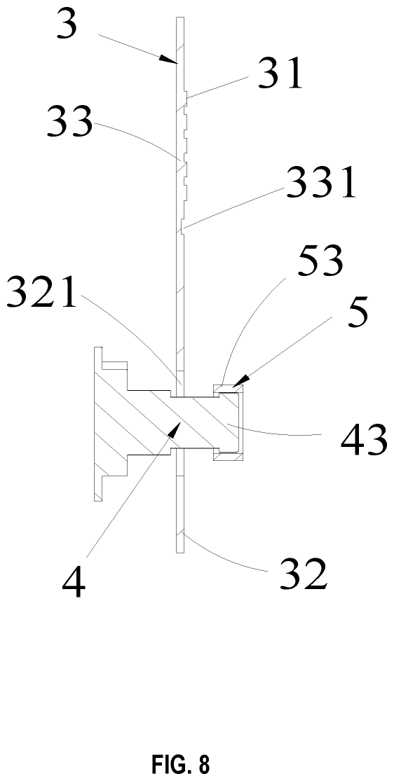

FIG. 8 is a cross-sectional view taken along the line B-B in FIG. 7;

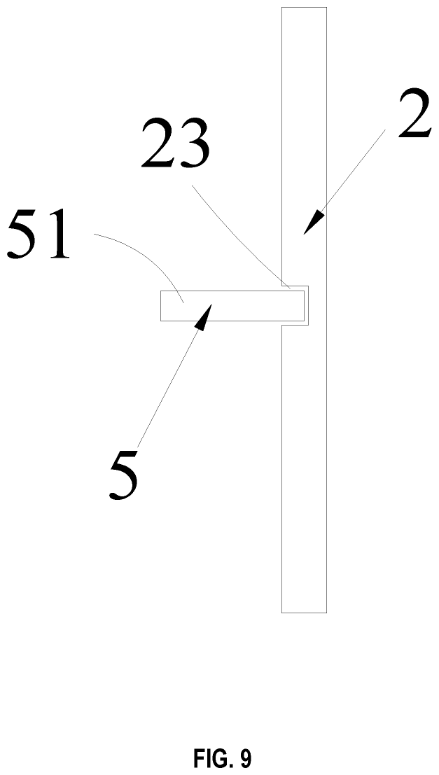

FIG. 9 is a schematic diagram when a second light blocking groove is provided on a front cover;

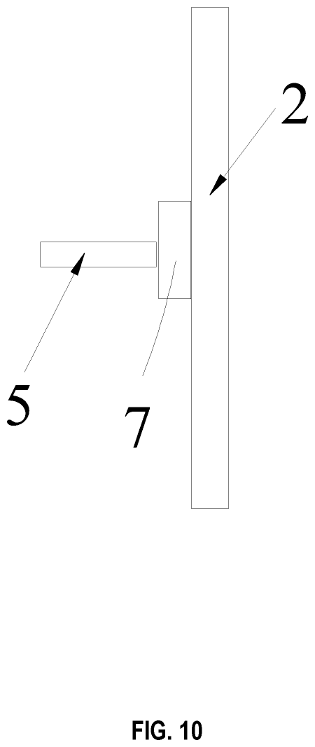

FIG. 10 is a schematic diagram when a flexible element is provided between a front cover and a light blocking element;

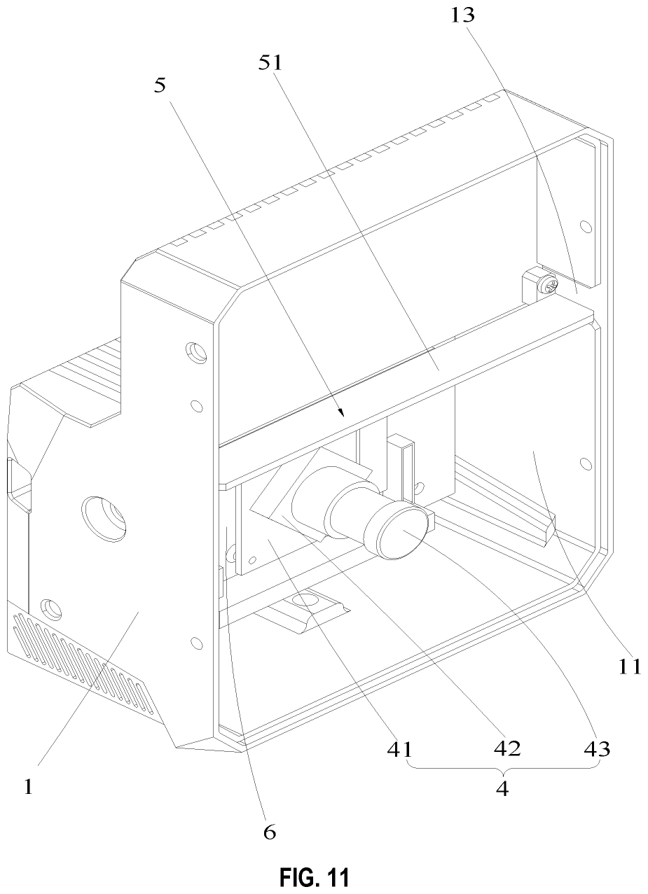

FIG. 11 is a schematic diagram of an inner structure of an accommodating groove of the housing;

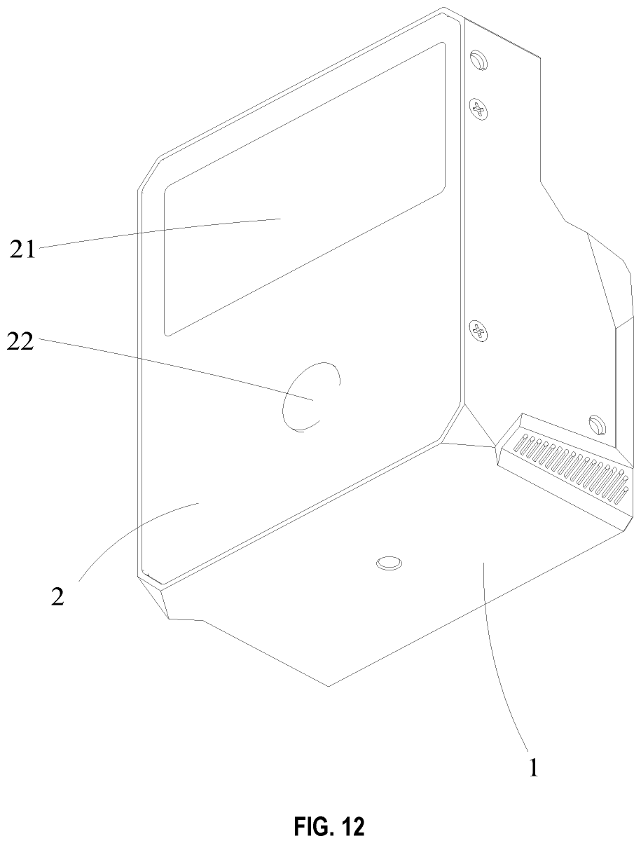

FIG. 12 is a schematic structural diagram of a flash LiDAR when a receiving window and an emitting window are provided on the front cover; and

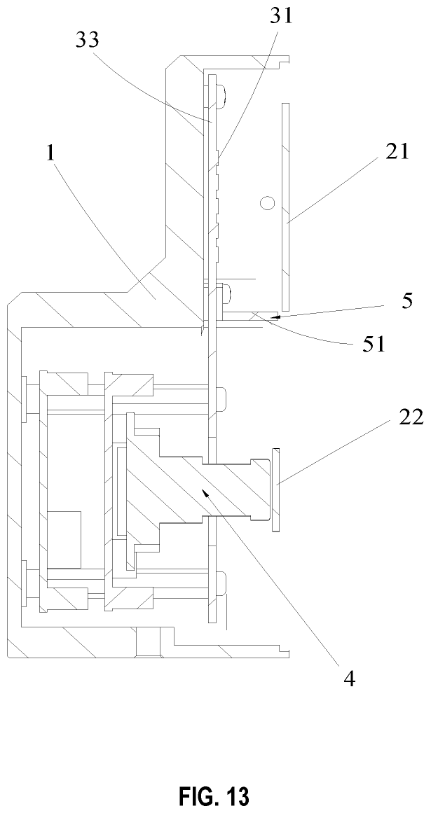

FIG. 13 is a cross-sectional view of the flash LiDAR in FIG. 11;

Reference numerals in the figures are as follows:

Housing 1; Accommodating groove 11; Heat sink rib 12; Mounting groove 13; Front cover 2; Emitting window 21; Receiving window 22; Second light blocking groove 23; Emitting assembly 3; Light-emitting element 31; Mounting plate 32; Spacing hole 321; Emitting board 33; First light blocking groove 331; Receiving assembly 4; Receiving board 41; Receiver 42; Receiving lens 43; Light blocking element 5; Light blocking plate 51; Second light blocking ring 52; First light blocking ring 53; Control assembly 6; Main control circuit board 61; Data processing circuit board 62; and Flexible element 7.

### DETAILED DESCRIPTION

To more clearly describe the technical problems to be solved with this disclosure, technical solutions, and beneficial effects, the following further describes this disclosure in detail with reference to the accompanying drawings and embodiments. It should be understood that the specific embodiments described herein are only used to explain this disclosure, and are not intended to limit this disclosure.

It should be noted that when being “fastened to” or “provided on” another element, an element can be directly or indirectly located on the another element. When being “connected to” another element, an element can be directly or indirectly connected to the another element.

It should be understood that azimuth or position relationships indicated by terms such as “length,” “width,” “above,” “under,” “front,” “rear,” “left,” “right,” “vertical,” “horizontal,” “top,” “bottom,” “inner,” and “outer” are based on the azimuth or position relationships shown in the accompanying drawings, are merely intended to describe this solution and simplify the descriptions, but are not intended to indicate or imply that the specified device or element shall have a specific azimuth or be formed and operated in a specific azimuth, and therefore cannot be understood as a limitation to this solution.

In addition, the terms such as “first” and “second” are merely intended for a purpose of description, and shall not be understood as an indication or implication of relative importance or implicit indication of a quantity of indicated technical features. Therefore, a feature with a determiner such as “first” or “second” may expressly or implicitly include one or more features. In the description in this disclosure, “a plurality of” means two or more, unless otherwise specifically defined.

However, a receiving assembly of the LiDAR in the prior art cannot receive sufficient reflected lasers reflected by the target object in the near field, thereby causing an inaccurate detection result. The problems can't be solved with emitting assemblies of different intensities, transparent sheets of different specifications and transmittance, or receiving assemblies of different specifications in a plurality of tests. In addition, the problems can't be solved with a plurality of random combinations of emitting assemblies of different intensities, transparent sheets of different specifications and transmittance, or receiving assemblies of different specifications. After the plurality of tests, it is assumed that the problem is that an outgoing laser emitted by the emitting assembly is received by the receiving assembly inside the LiDAR (the outgoing laser emitted by the emitting assembly is at a specific emission angle, and some outgoing lasers are directly emitted to the receiving assembly), and therefore, leading interference is caused to the receiving assembly, and the LiDAR experiences near-field saturation (that is, the receiving assembly cannot receive sufficient reflected lasers reflected by the near-field detected object). The reason is as follows: the receiving assembly has limited receiving capacity and a limited refreshing frequency, a reflected laser from the near-field detected object reaches the receiving assembly within a short time, and in a case that the receiving assembly receives a large amount of stray light that is directly emitted by the emitting assembly without being reflected by the detected object, the receiving assembly is in a saturated state. Before the receiving assembly is refreshed, the reflected laser from the near-field detected object reaches the receiving assembly, and as a result, the receiving assembly cannot respond to the reflected laser from the near-field detected object in a timely manner, thereby causing an inaccurate detection result in the near field and an apparent near-field blind spot.

Referring to FIG. 1 to FIG. 3, the flash LiDAR provided in this disclosure is described. The flash LiDAR includes: an emitting assembly 3, a receiving assembly 4, a light blocking element 5, and a control assembly 6. The emitting assembly 3 includes at least one light-emitting element 31, where the at least one light-emitting element 31 is arranged in an array, and is configured to emit an outgoing laser to a detection region; the receiving assembly 4 is configured to receive a reflected laser returning after being reflected by an object in the detection region, where the emitting assembly 3 and the receiving assembly 4 are arranged abreast; the light blocking element 5 is configured to block stray light directed to the receiving assembly 4; and the control assembly 6 is electrically connected with the emitting assembly 3 and the receiving assembly 4.

The flash LiDAR includes the emitting assembly 3 for emitting the outgoing laser to the detection region, and the receiving assembly 4 for receiving the reflected laser. The emitting assembly 3 and the receiving assembly 4 are arranged abreast. Without a need of a mechanically movable component, the emitting assembly 3 and the receiving assembly 4 are used to detect the detection region, thereby implementing solid-state laser scanning and detection. Because the emitting assembly 3 of the flash LiDAR uses the light-emitting element 31 arranged in the array to emit outgoing lasers, the outgoing lasers are at a relatively large divergence angle, and as a result, some outgoing lasers are directly emitted to the receiving assembly 4. In addition, the outgoing lasers are reflected or scattered by a device (for example, a transparent sheet) inside the flash LiDAR before being emitted outward. These emitted or scattered lasers and the outgoing lasers directly emitted to the receiving assembly 4 are collectively referred to as stray light.

In existing art, the receiving assembly 4 may receive the stray light before the reflected laser, and as a result, the receiving assembly 4 may be saturated and cannot receive the reflected laser returning after being reflected by a short-range target object. The flash LiDAR provided in the present disclosure uses the light blocking element 5 to stop the stray light from being directly emitted to the receiving assembly 4, so that the receiving assembly 4 does not receive the stray light, thereby avoiding causing a problem of leading interference. In addition, the light blocking element 5 stops the stray light from being directly emitted to the receiving component, the receiving assembly 4 can quickly respond to the reflected laser reflected by the short-range target object, and therefore, the receiving assembly 4 can accurately and effectively detect the short-range target object. The control assembly 6 identifies the target object by dealing with reflected lasers received by the receiving assembly 4, thereby effectively shrinking a short-range blind spot, ensuring accuracy and reliability of near-field detection of the flash LiDAR, and improving safety of the flash LiDAR as it is used.

Further, in a specific embodiment of the flash LiDAR provided in this disclosure, the emitting assembly 3 and the receiving assembly 4 are arranged opposite to each other in a horizontal direction and spaced apart, that is, the light-emitting element 31 and the receiving assembly 4 are at different locations in a width direction of the flash LiDAR, thereby effectively preventing light emitted by the light-emitting element 31 from being directly emitted to the receiving assembly 4. Alternatively, referring to FIG. 3, the light-emitting element 31 and the receiving assembly 4 are arranged opposite to each other in a vertical direction and spaced apart, that is, the light-emitting element 31 and the receiving assembly 4 are at locations of different heights in the flash LiDAR, thereby effectively preventing light emitted by the light-emitting element 31 from being directly emitted to the receiving assembly 4.

Further, referring to FIG. 3 and FIG. 11, in a specific embodiment of the flash LiDAR provided in this disclosure, the emitting assembly 3 further includes an emitting board 33, and the light-emitting element 31 is arranged on the emitting board 33; and the light-emitting element 31 is arranged on the emitting board 33 in the array, and emits outgoing lasers to illuminate a large detection region at a time without a need of scanning by a deflection component, thereby implementing solid-state scanning and detection. The receiving assembly 4 includes a receiving lens 43, a receiver 42, and a receiving board 41. The receiver 42 is arranged on the receiving board 41, and the receiving lens 43 is arranged on a front side of the receiver 42. The receiving lens 43 can be a passive optical lens group, and the lens group is provided in a cylindrical lens barrel. After being focused by the receiving lens 43, the reflected laser is received by the receiver 42; and because a photosensitive surface area of the receiver 42 is relatively small, the focused reflected laser is directed to the receiver 42, thereby improving receiving efficiency and effectively improving a detection capability and detection quality.

Further, referring to FIG. 2 and FIG. 13, in a specific embodiment of the flash LiDAR provided in this disclosure, the flash LiDAR further includes a housing 1 and a front cover 2, the housing 1 and the front cover 2 are assembled to form a sealed accommodating groove 11, and the emitting assembly 3, the receiving assembly 4, and the light blocking element 5 are all arranged in the accommodating groove 11. This provides a good working environment for an internal device, block interference such as external dust and raindrops, and prevent external ambient light from affecting the receiving assembly 4, so that the receiving assembly 4 can quickly respond to a reflected laser reflected by a short-range target object.

Further, referring to FIG. 2 and FIG. 3, in a specific embodiment of the flash LiDAR provided in this disclosure, the front cover 2 is a complete transparent sheet, or referring to FIG. 12, the front cover 2 is provided with an emitting window 21 corresponding to the emitting assembly 3 and a receiving window 22 corresponding to the receiving assembly 4, and both the emitting window 21 and the receiving window 22 are provided with the transparent sheet. The transparent sheets at the emitting window 21 and the receiving window 22 can have different transmittance. The transparent sheet at the emitting window 21 is conducive to outgoing lasers, and the transparent sheet at the receiving window 22 is conducive to incoming lasers and can block interference from the external ambient light.

Further, referring to FIG. 3, FIG. 6, and FIG. 8, in a specific embodiment of the flash LiDAR provided in this disclosure, an incident end of the receiving lens 43 protrudes from a plane in which a surface of the emitting board 33 is located, that is, a plane in which the light-emitting element 31 is located (the emitting board 33) is not co-planar with a surface of an end of the receiving assembly 4 for receiving the reflected laser (an incident end of the receiving lens 43), and therefore, the outgoing laser emitted by the light-emitting element 31 is further prevented from being directly transmitted to the receiving assembly 4. Stray light received by the receiving assembly 4 is reduced. This ensures accuracy of detecting a near-field detected object by the flash LiDAR, and effectively reduces the near-field blind spot.

Further, referring to FIG. 8, FIG. 9, FIG. 11, and FIG. 13, in a specific embodiment of the flash LiDAR provided in this disclosure, the light blocking element 5 is a light blocking plate 51, and arranged between the emitting assembly 3 and the receiving assembly 4. The emitting board 33 is provided with a first light blocking groove 331, and the light blocking plate 51 is inserted into the first light blocking groove 331 and protrudes from the surface of the emitting board 33. When the light blocking element 5 is the light blocking plate 51, the light blocking plate 51 is inserted into the first light blocking groove 331 and protrudes from the surface of the emitting board 33, so that the outgoing laser emitted by the light-emitting element 31 does not pass through a gap between the light blocking element 5 and the emitting board 33 to be directly transmitted to the receiving assembly 4, thereby further ensuring that the outgoing laser emitted by the light-emitting element 31 is not directly transmitted to the receiving assembly 4. This ensures the accuracy of detecting a near-field detected object by the flash LiDAR, and effectively reduces the near-field blind spot.

Further, in a specific embodiment of the flash LiDAR provided in this disclosure, a cross-section of the light blocking plate 51 is line-shaped, L-shaped, or T-shaped. When the cross-section of the light blocking plate 51 is L-shaped or T-shaped, the thickness of the light blocking plate 51 in a vertical direction on a side close to the front cover 2 is greater than the thickness of a main body of the light blocking plate 51, thereby effectively preventing light emitted along an edge on a side of the light blocking plate 51 close to the front cover 2 from passing through the gap between the light blocking plate 51 and the front cover 2 and then being received by the receiving assembly 4 after being reflected by the front cover 2.

Further, referring to FIG. 11, in a specific embodiment of the flash LiDAR provided in this disclosure, an inner surface of the housing 1 is provided with a mounting groove 13, an end of the light blocking plate 51 is inserted into the mounting groove 13, and the mounting groove 13 is located on two opposite side walls of the housing 1. The end of the light blocking plate 51 is inserted into the mounting groove 13, to prevent the outgoing laser emitted by the light-emitting element 31 from passing through a gap between an inner wall of the housing 1 and the end of the light blocking plate 51 and then being transmitted to the receiving assembly 4, thereby further preventing the outgoing laser emitted by the light-emitting element 31 from being directly transmitted to the receiving assembly 4. This ensures accuracy of detecting a near-field detected object by the flash LiDAR, and effectively reduces the near-field blind spot.

Further, referring to FIG. 8, in a specific embodiment of the flash LiDAR provided in this disclosure, the light blocking element 5 is a first light blocking ring 53, and arranged at an incident end of the receiving lens 43, and the first light blocking ring 53 is connected to a lens barrel at the incident end of the receiving lens 43. The first light blocking ring 53 can effectively stop the stray light from being emitted to the receiving lens 43 of the receiving assembly 4, the receiving assembly 4 can quickly respond to the reflected laser reflected by the short-range target object, and therefore, the receiving assembly 4 can accurately and effectively detect the short-range target object. This ensures the accuracy of detecting the near-field detected object by the flash LiDAR, and effectively reduces the short-range blind spot.

Further, referring to FIG. 7 and FIG. 8, in a specific embodiment of the flash LiDAR provided in this disclosure, a cross-section of the first light blocking ring 53 is circular or arc-shaped, the first light blocking ring 53 can surround the outside of the receiving assembly 4 and stop the stray light from being emitted to the receiving assembly 4, and the first light blocking ring 53 is cylindrical or inverted conical, and can both block and direct the light.

Further, referring to FIG. 4 to FIG. 8, in a specific embodiment of the flash LiDAR provided in this disclosure, the flash LiDAR further includes a mounting plate 32 extending along the emitting board 33 toward a side of the receiving assembly 4, the emitting board 33 and the mounting plate 32 are located on the same plane, the mounting plate 32 is provided with a spacing hole 321 corresponding to the receiving assembly 4, and the spacing hole 321 and the emitting assembly 3 are respectively located on two sides of the light blocking element 5, so that the light blocking element 5 blocks the light from the emitting assembly 3 and the receiving assembly 4 on two sides of the light blocking element 5, thereby effectively preventing the outgoing laser emitted by the light-emitting element 31 of the emitting assembly 3 from being directly transmitted to the receiving assembly 4. This ensures the accuracy of detecting the near-field detected object by the flash LiDAR, and effectively reduces the short-range blind spot.

Further, referring to FIG. 5 and FIG. 6, in a specific embodiment of the flash LiDAR provided in this disclosure, the light blocking element 5 is a second light blocking ring 52, and the second light blocking ring 52 is arranged around the spacing hole 321. Because the light blocking element 5 is the second light blocking ring 52 arranged around the spacing hole 321, the light blocking element 5 prevents the outgoing laser emitted by the light-emitting element 31 of the emitting assembly 3 from being directly transmitted to the receiving assembly 4. This ensures the accuracy of detecting the near-field detected object by the flash LiDAR, and effectively reduces the short-range blind spot.

Further, referring to FIG. 9, in a specific embodiment of the flash LiDAR provided in this disclosure, a second light blocking groove 23 is provided on an inner side of the front cover 2, and the light blocking element 5 is inserted into the second light blocking groove 23 and protrudes from a surface of the front cover 2. The light blocking element 5 is inserted into the second light blocking groove 23 and protrudes from the surface of the front cover 2, so that the outgoing laser emitted by the light-emitting element 31 does not pass through a gap between the light blocking element 5 and the front cover 2 to be directly transmitted to the receiving assembly 4 (or reflected by the front cover 2 to the receiving assembly 4), thereby further ensuring that the outgoing laser emitted by the light-emitting element 31 is not directly transmitted to the receiving assembly 4. This ensures the accuracy of detecting a near-field detected object by the flash LiDAR, and effectively reduces the near-field blind spot.

Further, referring to FIG. 10, in a specific embodiment of the flash LiDAR provided in this disclosure, a flexible element 7 is provided between the front cover 2 and the light blocking element 5, and two sides of the flexible element 7 abut the front cover 2 and the light blocking element 5 respectively. The flexible element 7 can flexibly deform, to block a gap between the front cover 2 and the light blocking element 5, so that the outgoing laser emitted by the light-emitting element 31 does not pass through the gap between the light blocking element 5 and the front cover 2 to be directly transmitted to the receiving assembly 4, thereby further ensuring that the outgoing laser emitted by the light-emitting element 31 is not directly transmitted to the receiving assembly 4. This ensures the accuracy of detecting a near-field detected object by the flash LiDAR, and effectively reduces the near-field blind spot.

Further, referring to FIG. 3, in a specific embodiment of the flash LiDAR provided in this disclosure, the control assembly 6 includes a main control circuit board 61 and a data processing circuit board 62 electrically connected to the main control circuit board 61, the receiving board 41 of the receiving assembly 4 is electrically connected to the data processing circuit board 62, and the receiving board 41 is configured to convert a received reflected laser into an electrical signal and then transfer the electrical signal to the data processing circuit board 62.

Further, referring to FIG. 3, in a specific embodiment of the flash LiDAR provided in this disclosure, the data processing circuit board 62 is fastened and connected to the main control circuit board 61, the data processing circuit board 62 is provided with a first connector, and the receiving board 41 is provided with a second connector that fits with the first connector, which helps quickly fit the receiving board 41 with the data processing circuit board 62.

Further, referring to FIG. 13 and FIG. 1, in a specific embodiment of the flash LiDAR provided in this disclosure, the emitting board 33 and the inner surface of the housing 1 are laminated, and an outer surface of the housing 1 is provided with a plurality of heat sink ribs 12. Heat generated when the light-emitting element 31 emits light can be quickly transferred to the housing 1 through the emitting board 33 for outward heat dissipation. The heat sink ribs 12 on the housing 1 increase a heat dissipation area and improve heat dissipation efficiency.

Further, in a specific embodiment of the flash LiDAR provided in this disclosure, the transparent sheet is coated with an anti-reflection layer, to improve the transmittance of the transparent sheet on the front cover 2, thereby ensuring sufficient outgoing lasers and further improving detection accuracy of the LiDAR.

The foregoing descriptions are only preferred embodiments of this disclosure, and are not intended to limit this disclosure. Any modification, equivalent replacement and improvement made within the spirit and principle of this disclosure shall be included within the protection scope of this disclosure.

What is claimed is:

1. A flash LiDAR, comprising:
an emitting assembly, comprising at least one light-emitting element, wherein the at least one light-emitting element is arranged in an array and configured to emit an outgoing laser to a detection region;
a receiving assembly, configured to receive a reflected laser returning after being reflected by an object in the detection region, wherein the emitting assembly and the receiving assembly are arranged abreast;
a light blocking element, configured to block stray light directed to the receiving assembly; and
a control assembly, electrically connected with the emitting assembly and the receiving assembly.

2. The flash LiDAR of claim 1, wherein the emitting assembly and the receiving assembly are arranged opposite each other in a horizontal direction and spaced apart, or the light-emitting element and the receiving assembly are arranged opposite each other in a vertical direction and spaced apart.

3. The flash LiDAR of claim 1, wherein the emitting assembly further comprises an emitting board,
wherein the light-emitting element is arranged on the emission board, and
wherein the receiving assembly comprises:
a receiving lens, a receiver, and a receiving board,
wherein the receiver is arranged on the receiving board, and
wherein the receiving lens is arranged on a front side of the receiver.

4. The flash LiDAR of claim 3, further comprising:
a housing and a front cover,
wherein the housing and the front cover are assembled to form a sealed accommodating groove, and
wherein the emitting assembly, the receiving assembly, and the light blocking element are all arranged in the accommodating groove.

5. The flash LiDAR of claim 3, wherein an incident end of the receiving lens protrudes from a plane in which a surface of the emitting board is located.

6. The flash LiDAR of claim 3, wherein the light blocking element is a light blocking plate, and arranged between the emitting assembly and the receiving assembly,
wherein the emitting board is provided with a first light blocking groove, and
wherein the light blocking plate is inserted into the first light blocking groove and protrudes from the surface of the emission board.

7. The flash LiDAR of claim 6, wherein a cross-section of the light blocking plate is line-shaped, L-shaped, or T-shaped.

8. The flash LiDAR of claim 6, wherein an inner surface of the housing is provided with a mounting groove,
wherein an end of the light blocking plate is inserted into the mounting groove, and
wherein the mounting groove is located on two opposite side walls of the housing.

9. The flash LiDAR of claim 3, wherein the light blocking element is a first light blocking ring, and arranged at an incident end of the receiving lens, and
wherein the first light blocking ring is connected to a lens barrel at the incident end of the receiving lens.

10. The flash LiDAR of claim 9, wherein a cross-section of the first light blocking ring is circular or arc-shaped, and
wherein the first light blocking ring is cylindrical or inverted conical.

11. The flash LiDAR of claim 3, further comprising:
a mounting plate extending along the emitting board toward a side of the receiving assembly,
wherein the emitting board and the mounting plate are located on the same plane,
wherein the mounting plate is provided with a spacing hole corresponding to the receiving assembly, and
wherein the spacing hole and the emitting assembly are respectively located on two sides of the light blocking element.

12. The flash LiDAR of claim 11, wherein the light blocking element is a second light blocking ring, and
wherein the second light blocking ring is arranged around the spacing hole.

13. The flash LiDAR of claim 4, wherein the front cover is in one of the following two forms:
a complete transparent sheet, or
the front cover is provided with an emitting window corresponding to the emitting assembly and a receiving window corresponding to the receiving assembly, and both the emitting window and the receiving window are provided with the transparent sheet.

14. The flash LiDAR of claim 4, wherein a second light blocking groove is provided on an inner side of the front cover, and
wherein the light blocking element is inserted into the second light blocking groove and protrudes from a surface of the front cover.

15. The flash LiDAR of claim 4, wherein a flexible element is provided between the front cover and the light blocking element, and
wherein two sides of the flexible element abut the front cover and the light blocking element respectively.

16. The flash LiDAR of claim 3, wherein the control assembly comprises:
a main control circuit board, and
a data processing circuit board electrically connected to the main control circuit board,
wherein the receiving board of the receiving assembly is electrically connected to the data processing circuit board, and
wherein the receiving board is configured to convert the reflected laser into an electrical signal and then transmit the electrical signal to the data processing circuit board.

17. The flash LiDAR of claim 16, wherein the data processing circuit board is fastened and connected to the main control circuit board,
wherein the data processing circuit board is provided with a first connector, and
wherein the receiving board is provided with a second connector that matches with the first connector.

18. The flash LiDAR of claim 4, wherein the emitting board and the inner surface of the housing are laminated, and
wherein an outer surface of the housing is provided with a plurality of heat sink ribs.

19. The flash LiDAR of claim 13, wherein the transparent sheet is coated with an anti-reflection layer.
